(19) United States
(12) Patent Application Publication
(10) Pub. No.: US 2017/0028421 A1
(43) Pub. Date: Feb. 2, 2017

(54) BOTTLE

(71) Applicant: QUALIPAC, Neuilly Sur Seine (FR)

(72) Inventor: Gérald Martines, Paris (FR)

(73) Assignee: QUALIPAC, Neuilly Sur Seine (FR)

(21) Appl. No.: 15/302,832

(22) PCT Filed: Apr. 8, 2015
(86) PCT No.: PCT/FR2015/050909

§ 371 Date: Oct. 7, 2016

(30) Foreign Application Priority Data
Apr. 8, 2014 (FR) 14 53111

(51) Int. Cl. B05B 11/00; B65D 1/02; A45D 40/24; A45D 34/02; A45D 34/04; A45D 40/26; B65D 1/04; B65D 47/20

(52) U.S. Cl. CPC B05B 11/3084; B65D 1/04; B65D 1/0207; B65D 47/20; A45D 34/02; A45D 34/04; A45D 40/26; A45D 40/24; B05B 11/3081; B05B 11/0037; B05B 11/3047

(57) ABSTRACT

A bottle comprising a glass container equipped with a mouth, and a closure system that is hermetically assembled to the glass container such as to close the mouth. The closure system comprises an outer cover and a dispensing through-hole. The bottle comprises a product dispensing system including at least one dispensing member assembled so that it can access any product contained in the bottle, through the dispensing through-hole. The closure system and the dispensing system cooperate such as to provide a functional dispensing interaction.

The invention relates to the field of bottles.

The term “bottle” is used here to designate a rigid object intended to hold fluid content (liquid, viscous, or pasty) to be dispensed. Such a bottle may have a closed and sealed configuration in which the fluid cannot freely leave the bottle. Such a bottle may also be placed in a dispensing configuration, in which the content is dispensed from the bottle. Such bottles are used in the field of cosmetics or spirits.

Rigid plastic bottles exist which allow great freedom in their shape or production method. For example, US 2010/116,769 discloses various embodiments of a plastic bottle for sports drinks, which the user must compress to force out the contents. Plastic bottles are not suitable for some market segments, however, where bottles including a glass container are traditionally used. However, glass is a material that is difficult to implement from an industrial point of view, due to its demanding manufacturing process (in particular the high temperatures), which can result in variations in the resulting products due to manufacturing tolerances. These variations pose problems when it comes to achieving reliable and durable fluidtightness of the bottle in its closed configuration.

Although US 2010/116,769 also claims that glass is possible as the component material of this sports drink bottle, it is immediately apparent from the description of the various functions required for this product that glass is not feasible. U.S. Pat. No. 6,179,146 describes a product that at first inspection seems to be made of plastic. US 2011/036,867 describes a “product” which one doubts is even feasible, whether in plastic or in glass.

To reduce the abovementioned problems concerning the fluidtightness of glass products, a blowing process is traditionally used which allows defining a glass container of large capacity, with a narrow neck where the sealing function is implemented. As the glass neck is narrow, it is possible to oversize the sealing solution to ensure that a fluidtight bottle is provided despite variations from the manufacturing process. The narrow neck can typically receive a dispensing member such as a pump for example, that is assembled onto the neck by any suitable technique such as crimping, snap-fitting, screwing, etc. US 2009/308,890, FR 2 970 414, or FR 2 952 913 are examples of such a container, assuming they are made of glass.

Recently, there have been efforts to move away from the traditional shape of glass bottles having a narrow neck. A process called “direct press” was presented in EP 2,602,232. This process can certainly be supplemented with a blowing step where appropriate, but the basic geometry of the glass container is still able to provide a large opening in comparison to traditional necks. With such large openings, sealing issues become complex. For glass products with large openings, as suggested for example by US 2012/006,853, KR 2011/103200, U.S. Pat. No. 5,454,488, or DE 10 2007 060 359 (assuming they are made of glass), these issues are resolved only because of the rotationally symmetrical geometry of the mouth, thereby ensuring a high peripheral uniformity in the constraints at that point.

The direct press method discussed above also allows providing different cross-sectional profiles for the opening, and in particular non-circular profiles. For such profiles, the sealing issues are again complex due to the peripheral non-uniformity. In addition, as the glass container no longer has a narrow neck, one can no longer make use of traditional assembly technology for the dispensing member.

Furthermore, there is always a search for ways to diversify bottle product lines and enhance existing bottles with new features, to enable the development of innovative products.

A description of the invention is provided below.

According to a first aspect, the invention relates to a bottle comprising:
a glass container body comprising a mouth of non-circular shape,
a closure system hermetically assembled to the glass container body so as to close the mouth, the closure system comprising an outer cover, the closure system comprising a dispensing through-hole,
a product dispensing system comprising at least one dispensing member assembled so as to provide access to a product that may be contained in the bottle, through the dispensing through-hole,
   wherein the closure system and the dispensing system cooperate to further provide a functional dispensing interaction.

With these arrangements, the dispensing member can be assembled in the conventional manner, except that this assembly is done onto a part that is not necessarily glass which eliminates some constraints related to the glass manufacturing process, giving it other functions.

In one embodiment, the dispensing through-hole is a first dispensing through-hole, the dispensing member is a first dispensing member, the closure system comprises a second dispensing through-hole, and the product dispensing system comprises a second dispensing member assembled to the closure system, to provide access to a product that may be contained in the bottle, through the second dispensing through-hole.

In one embodiment, the first and second dispensing members differ in at least one characteristic selected from the following:
the volume dispensed by the dispensing,
the dispensing mode,
the dispensing type,
in the case of dispensing by spraying, the size distribution of the sprayed droplets,
in the case of dispensing by spraying, the spatial three-dimensional shape of the dispensed volume.

In one embodiment, the closure system is assembled to the glass container body so as to define first and second receptacles that are sealed relative to one another, and the first dispensing member is adapted to provide access to a product contained in the first receptacle, and the second dispensing member is adapted to provide access to a product contained in the second receptacle.

In one embodiment, the first and second receptacles have one or more of the following characteristics:
an identical external shape,
an external shape that is symmetrical to one another,
an external shape that is different from one another,
an external shape that is asymmetrical to one another,
an identical internal shape,
an internal shape that is symmetrical to one another,
an internal shape that is different from one another,
an internal shape that is asymmetrical to one another,
an identical volume plus or minus 10%,
a volume that differs by at least 10%,
a volume that differs by at least 50%,
identical external decoration,
different external decoration,
identical internal decoration,
different internal decoration.

In one embodiment, the two receptacles are hermetically defined relative to one another by a casing attached to the closure system.

In one embodiment, the mouth comprises an assembly interface, the closure system comprises a base, a sealing interface extending from the base, the assembly interface of the mouth and the sealing interface of the closure system cooperating for a hermetic assembly of the closure system and the glass container body, at least one dispensing through-hole and in particular each dispensing through-hole being formed in the base.

In one embodiment, the base forms the outer cover.

In one embodiment, the closure system comprises a sealing part and a locking part covering the sealing system, the locking part forming the cover, the dispensing through-hole being formed by the superposition of a through-hole in the locking part and a through-hole in the sealing part, through which the dispensing member extends.

In one embodiment, the locking part clasps the sealing part to ensure the hermetic assembly between the closure system and the glass container body.

In one embodiment, the closure system comprises a neck, the dispensing through-hole is created at least partially in the neck, and the dispensing member is assembled onto the neck of the closure system.

In one embodiment, the neck extends outwardly from the outer cover.

In one embodiment, the neck is provided by a plastic part.

In one embodiment, the sealing part provides the neck.

In one embodiment, the cover forms a housing for the dispensing member, the closure system and the dispensing system cooperating to provide a functional dispensing interaction that protects against accidental actuation of the dispensing member.

In one embodiment, the cover has at least one wall partially surrounding the dispensing member and extending about a longitudinal axis of the dispensing member.

In one embodiment, the cover further has a wall extending transversely to the longitudinal axis of the dispensing member.

In one embodiment, a longitudinal axis of the dispensing member is oriented at an angle of at least 15° relative to a normal to the cover.

In one embodiment, the dispensing member is mounted so as to be movable relative to the cover between a first position and a second position with a first degree of freedom, the closure system comprising a system for stably retaining the dispensing member relative to the cover in at least one of the first and second positions, and in particular in both the first and second positions, the closure system and the dispensing system cooperating to provide a functional dispensing interaction with mobility.

In one embodiment, the system for stably retaining the dispensing member relative to the cover is suitable for stably retaining the dispensing member relative to the cover at least in one intermediate position between the first and second positions.

In one embodiment, the first degree of freedom is a translation along the longitudinal axis of the dispensing member.

In one embodiment, the first degree of freedom is a rotation about an axis of a plane normal to the longitudinal axis of the dispensing member.

In one embodiment, the closure system is hermetically assembled to the glass container body so as to close the mouth permanently.

In one embodiment, the glass container body is a first glass container body, the bottle further comprising a second glass container body secured to the first glass container body by a sealing connection system.

In one embodiment, the closure system and the dispensing system cooperate to provide a functional dispensing interaction with inclination between the dispensing system and the closure system.

In one embodiment, the closure system and the dispensing system cooperate to further provide a functional dispensing interaction that is decorative, the closure system providing a seat for a rigid decorative object inside the bottle without interfering with the dispensing of product.

In one embodiment, a volume defined by the closure system is at least 15%, possibly at least 50%, of the volume of the bottle.

The figures in the drawings are now briefly described.

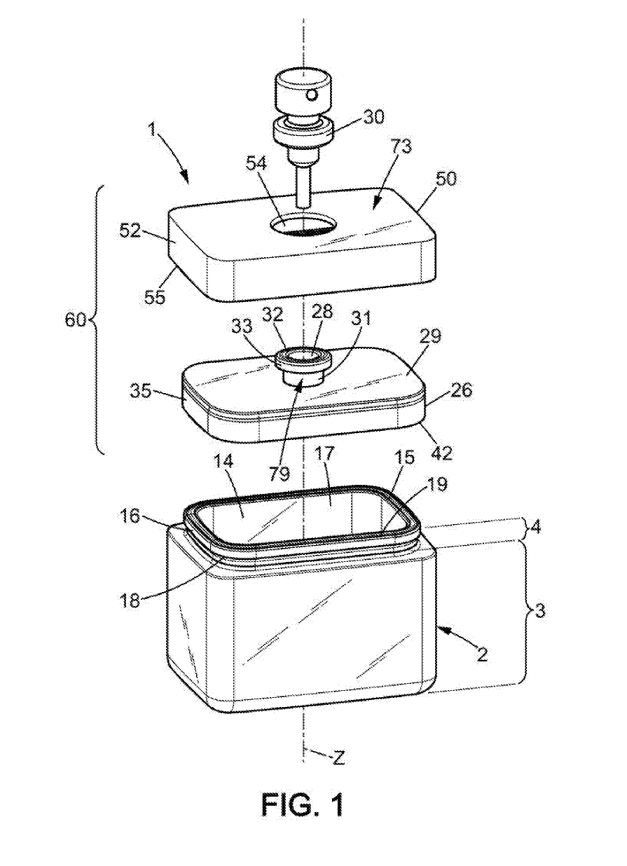

FIG. 1 is a diagram corresponding to a perspective view of a bottle.

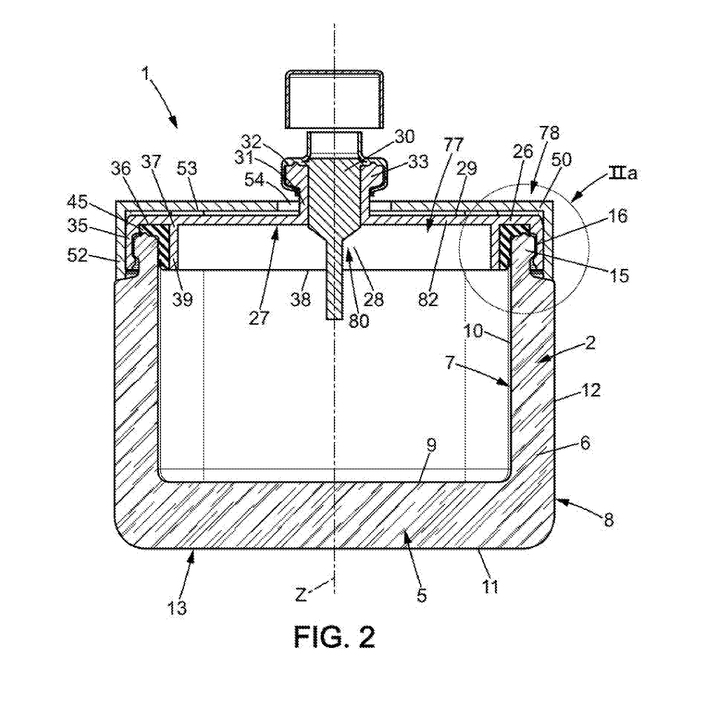

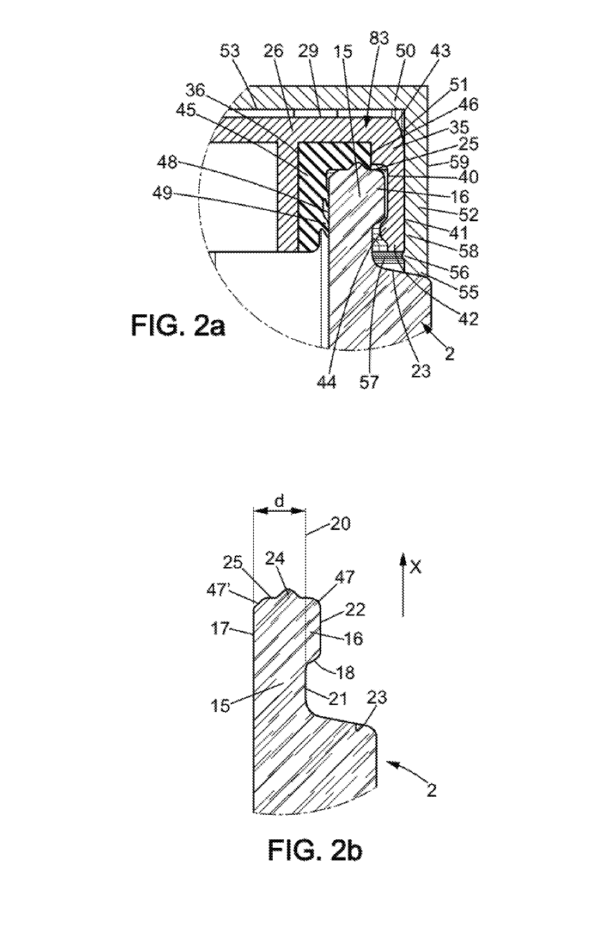

FIG. 2 is a sectional view of the bottle of FIG. 1.

FIGS. 2a and 2b are detail views of FIG. 2.

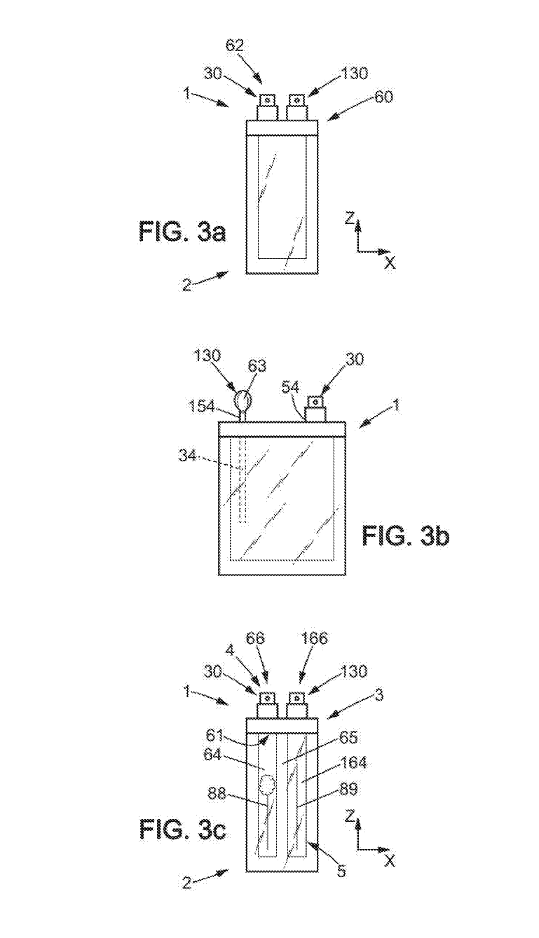

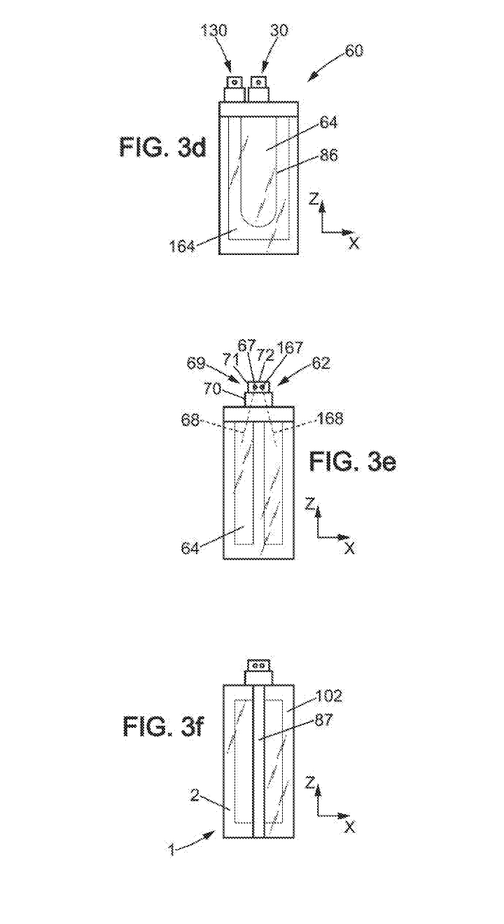

FIGS. 3a to 3f are similar front views of a bottle according to six embodiments.

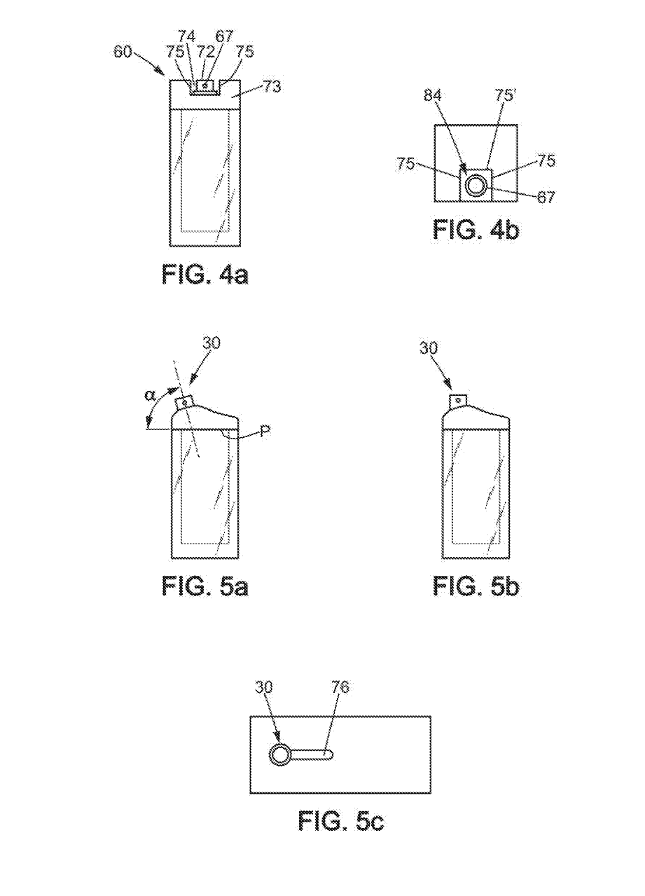

FIG. 4a is a front view of a bottle according to a seventh embodiment.

FIG. 4b is a top view of the bottle of FIG. 4a.

FIG. 5a is a front view of a bottle according to an eighth embodiment.

FIG. 5b is a front view of the bottle according to a ninth embodiment.

FIG. 5c is a schematic top view of the embodiment of FIG. 5b.

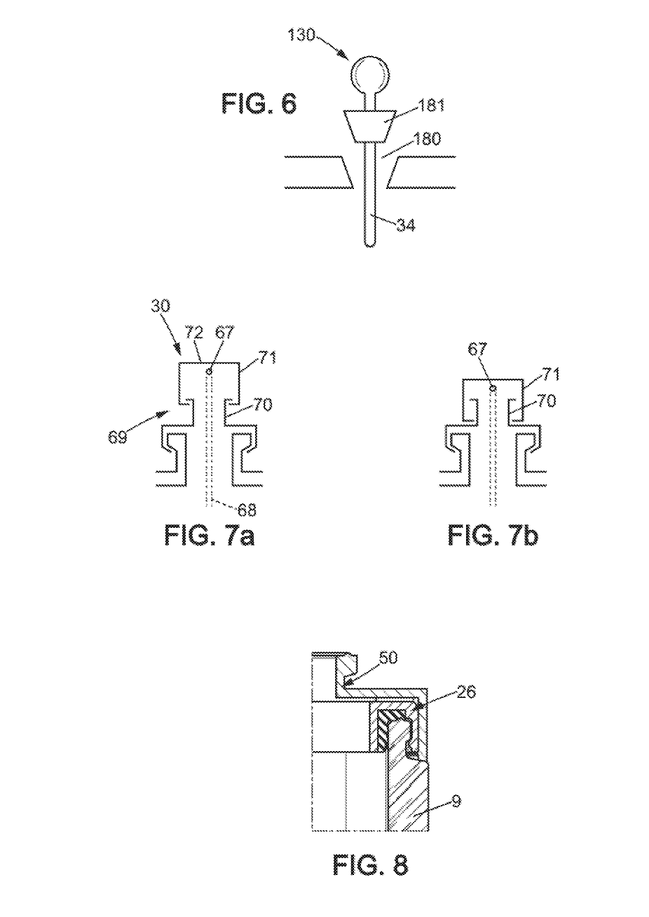

FIG. 6 is a schematic detail view of an implementation of FIG. 3b.

FIGS. 7a and 7b are functional diagrams of an exemplary dispensing member in two different configurations.

FIG. 8 is a partial schematic view of an alternative embodiment.

Below is a detailed description of several embodiments of the invention, accompanied by examples and with reference to the drawings.

FIG. 1 shows an exploded perspective view of a bottle 1 for cosmetic products or spirits according to one embodiment of the invention.

The bottle 1 comprises a container body 2 made of glass.

The glass container body 2 is mainly composed of glass. Any type of glass compatible with the intended application may be used, including types already currently in use in the bottle industry.

The glass container body 2 is, for example, created by a pressing process.

During such a process, a mold for the body, a mold for the opening, and a punch are used, together forming a cavity receiving a glass gob. The punch is movable relative to the molds, between a withdrawn position and an extended position in which the cavity defines the future shape of the container body 2. As is understood, the container body 2 therefore has a large opening to allow the passage of the punch. The punch defines the internal shape of the container body 2, and the molds its external shape. The mold for the opening can be used to shape an assembly interface of the container body 2, this assembly interface serving to close the bottle.

Where appropriate, the pressing step described above is followed by a blowing step, in which the reservoir portion of the main body is reshaped by blowing into its internal volume. This blowing step can increase the internal volume of the bottle by about 10% to 20%, if one wishes to maintain the geometric characteristics of the inside surface that were obtained during the pressing step. The term “pressed” as used here refers to any implementation that comprises a pressing step, including cases where this step is followed by such a blowing step.

In the example, the container body 2 has the general shape of a cylinder arranged along an axis Z and having a substantially rectangular external cross-section. When describing the shape of the container body 2, this primarily concerns the shape of its reservoir portion 3. The container body 2 has a reservoir portion 3 providing most of the volume of the container body 2, and an assembly interface 4 that is integral with the reservoir portion, to be described in more detail below. In other words, the container body 2 has a hollow shape which in itself is capable of holding a liquid or a paste. The container body 2 has a bottom 5 from which extends a peripheral wall 6. Thus, when we say that the container body 2 has the general shape of a cylinder, it is understood that the peripheral wall 6 has a generally cylindrical shape. The container body 2 comprises an inner face 7, intended to be in contact with the content of the container body 2, and an outer face 8 opposite to the inner face. The bottom 5 and the peripheral wall 6 thus each have an inner face, respectively 9 and 10, together forming part of the inner face 7 of the container body 2. The bottom 5 and the peripheral wall 6 thus each comprise an outer face, respectively 11 and 12, together forming part of the outer face 8 of the container body 2. In the example shown, the outer face 11 of the bottom 5 defines a bearing surface 13 of the container body 2. In other words, when stored normally, the container body 2 remains stable when placed with its bearing surface 13 resting on a horizontal surface of a support such as a piece of furniture. The peripheral wall 6 extends transversely to the bearing surface 13. In the example shown, it extends orthogonally to the bearing surface 13. Thus, when we say that the container body 2 has the general shape of a cylinder, this refers in particular to the general shape of the outer face 12 of the peripheral wall 6 between the base and the assembly interface. It is understood that “cylinder” is understood to mean a shape generated by the travel of a line (generatrix) parallel to an axis, tracing a closed profile of any shape. In the present example, the axis is normal to the bearing surface 13. In the present case, the closed profile is of substantially rectangular geometry. Substantially rectangular is understood here to mean a closed profile having the shape of a rectangle with rounded corners.

However, it is possible to adapt other shapes to the container body 2.

The container body 2 may, for example, have a generally polygonal shape. The polygonal shape is presented herein with reference to the substantially rectangular cross-section above. In other words, the closed profile mentioned above has a polygonal shape having at least three sides, typically a triangle, a quadrilateral such as a rhombus, a trapezoid, a square, a rectangle, a parallelepiped, or some other polygon of five or more sides. The polygon may either be regular (n-order symmetry, sides of equal length, etc.) or irregular. In addition, similarly to above for the rectangle, it may have a substantially polygonal shape, for example a polygon with rounded corners.

The container body 2 may, for example, have a generally spheroid shape. This is not in contrast to “rectangular” but rather to “cylindrical”. Thus, in this embodiment, the general external shape of the main body 3 of the container body 2 is a truncated half sphere. The peripheral wall 6 thus comprises an outer face 12 in the form of a sphere portion. The outer face 11 of the bottom 5 may be flat to serve as a bearing surface 13. The term “spheroid” refers to a geometry close to that of a sphere portion.

Thus, as has already been seen for two different embodiments, the external shape of the reservoir portion 3 of the container body 2 can vary widely, including a cylindrical shape having a substantially rectangular or polygonal profile or a spheroid shape. It is therefore understood that we are not limited to these two embodiments, and that others conceivable by a person skilled in the art could be provided, as long as they are compatible with the structure of the device. Possible variants are, for example, implemented from a cylindrical shape, having a cross-section perpendicular to the axis of the generatrix that is not necessarily constant but may vary, for example in a homothetic manner, for example by forming a converging or diverging cone, an indentation, or a bead.

One will note that in the foregoing, the described form primarily concerns the external shape of the container body 2. The internal shape of the container body 2 may be independent of its external shape, as long as that the container can be produced (in particular by a pressing process) and used in the desired configurations (which requires for example a minimum thickness of the glass for the desired application).

The container body 2 comprises an opening 14. The opening 14 here is opposite the bottom 5. In the example shown, the opening 14 is planar and of substantially rectangular shape. However, the opening 14 may be of any polygonal shape, or may be oval in shape.

The assembly interface 4 of the container body 2 has an edge portion 15 forming a bead 16. The bead 16 is provided substantially perpendicular to the axis Z. The bead 16 of the container body 2 is particularly visible in FIG. 2, FIG. 2a, and FIG. 2b. The edge portion 15 surrounds the opening 14. The edge portion 15 and the opening 14 together form the mouth 61 of the container body 2.

As can be seen in FIG. 1, the invention is particularly suitable for large openings. In a manner inherent to the pressing process, a punch of a size suitable for shaping the inside surface of the main body is passed through the opening 14. The opening 14 is therefore sufficiently large to allow the passage of this punch and is arranged suitably for the inner shape of the reservoir portion 3. Thus, if the punch is moved along a path, the cross-sectional shape of the opening 14 normal to this path covers the shape defined by the inner face of the reservoir portion normal to this path. In this cross-section, the largest dimension of the opening 14 is greater than 3 centimeters or possibly greater than 5 cm, particularly greater than 7 cm, more particularly greater than 10 cm.

The assembly interface 4 comprises an edge portion 15 of the container body 2. The edge portion 15 forms a bead 16. The assembly interface 4 extends along an assembly axis X. In the example presented, the assembly axis is coincident with the Z axis. The assembly interface 4 is formed integrally with the peripheral wall 6 of the container body 2. In the example shown, the assembly interface comprises an inner side surface 17 that is continuous with the inner face 10 of the peripheral wall 6 of the container body 2. The inner faces 10 and 17 may even be connected together to form a smooth surface with no shoulder or curvature. One will note that, alternatively, the inner side face 17 of the assembly interface 4 and the inner face 10 of the peripheral wall 6 are connected via a shoulder or some other dimensional pattern. The assembly interface 4 has an outer face 18 opposite to the inner side surface 17. Outer face 18 is connected to outer face 12 of the peripheral wall 6. An edge 19 of the assembly interface 4 extends between the inner side face 17 and outer face 18.

In practice, the assembly interface 4 consists of an annular body from which the bead 16 projects. The annular body forms a ring about the assembly direction X. The annular body is defined, on the radially inner side, by the inner side face 17 of the assembly interface 4. The annular body is defined, on the radially outer side, by a virtual geometric surface 20 parallel to the inner face 17 at a distance d from it which is constant along the entire periphery of the assembly interface.

In the example shown of a substantially rectangular shape, the annular body, in a given section plane that is normal to direction X, has a set of straight portions of thickness d, and rounded portions connecting the straight portions. The difference between the inner radius of curvature and the outer radius of curvature of the virtual geometric surface 20 is substantially d. The straight and rounded portions meet one another tangentially.

Where appropriate, the virtual geometric surface 20 intercepts or provides a common surface with the outer face 18 of the assembly interface 4.

In the example shown, the assembly interface 4 is of low height in comparison to its other two dimensions along the assembly direction, and it can be considered as lying in a plane which would be a midplane in the heightwise direction, normal to the assembly direction. When referring to the shape of the mouth, reference is made either to the shape of the inner face 17 in general, or to the cross-sectional shape of the virtual geometric surface 20 in this plane. Thus, when we say that the mouth is of substantially rectangular shape, this is referring to the particular embodiment of FIG. 1 where the cross-sectional external shape of the virtual geometric surface 20 is substantially rectangular. It is thus understood that the cross-section of the virtual geometric surface 20 of the edge portion 15 is substantially rectangular. Similarly, the cross-section of the inner face 17 is substantially rectangular. “Substantially” is used herein to designate a rectangle with rounded edges, as for the reservoir portion 3.

When referring to any polygonal or oval shape of the mouth, this also refers to the cross-sectional shape of the virtual geometric surface 20 orthogonal to the assembly direction.

In general, the invention finds particular application for a non-circular shape of the mouth, in other words the virtual geometric surface 20 of a cross-section normal to the assembly direction. As this concerns a non-circular shape, the skilled person knows the level of regularity to expect in a surface formed in a glass pressing process. A non-circular shape is considered to be such from the moment a skilled person is able to determine, when observing the shape, that it was deliberately manufactured to be non-circular. Thus, non-circular does not cover circular shapes in which shape defects due to the production process have changed the shape relative to a desired ideal geometric circle. For example, a non-circular shape will be considered to be such when there is a deviation of more than 2% between the nominal diameter of a surface in question and the diameters inscribed and circumscribed on the surface in question. A difference of more than 20% is quite possible. The shape in question is that of the inner surface 17, and/or the virtual geometrical surface 20, independently of any contours serving as catches, such as the bead 16.

The bead 16 may be continuous along the periphery of the container body 2, as shown. In a plane normal to the assembly direction, it may have a constant thickness, or a portion of constant thickness and portions having an increased thickness in comparison to this portion of constant thickness. Especially in areas of high curvature, there may be such an increased thickness.

Note that the shape of the outer face 18 is not necessarily of constant cross-section along an assembly axis. In particular, the shape may be homothetic along the assembly axis. Thus, in the cross-sections when progressing along the assembly axis, the edge portion 15 has a first narrowed portion 21 which may coincide with the virtual geometric surface 20, then an enlarged portion 22 forming the bead 16. The edge portion 15 may be thinner than the peripheral wall 6. In particular, if the inner side surface 17 of the annular portion is aligned in the same plane as the inner face 10 of the peripheral wall 6, the outer face 18 is located radially closer to the inner side surface 17 of the annular portion than the outer face 12 is to the inner face 10. Accordingly, the narrowed portion 21 forms a recess between the bead 16 and the peripheral wall 6. A shoulder 23 is provided at the connection between the peripheral wall 6 and the mouth.

In the example, the edge portion 15 of the container body 2 comprises a projecting element 24 (FIG. 2b), or rounded edge, arranged substantially perpendicular to an upper surface 25 of said edge portion. The rounded edge 24 has small dimensions compared to the bead 16.

In summary, the container body 2 has a reservoir portion 3 of any hollow shape, and an assembly interface 4 of a shape suitable for sealing the bottle. The assembly interface comprises an annular body from which a bead 16 projects. The annular body forms a ring along the entire periphery of the container body 2. The inner surface of this ring is a cylinder, in particular of non-circular cross-section. The cross-section is normal to the assembly direction. The outer surface (virtual surface defined by the virtual geometric surface 20) of this ring is a cylinder, in particular of non-circular cross-section. The reservoir portion 3 and the annular body are formed as one part and are connected together in a technically appropriate manner.

The opening of the container body 2 is wide. One will note, in the embodiment shown, that the annular body and the reservoir portion 3 may have dimensions of the same order of magnitude in a plane normal to the assembly direction. “Same order of magnitude” is understood to mean that the inner surface of the annular body allows the passage of a rigid volume corresponding to a homothetic scaling at a ratio of between 75% and 120% of the volume defined by the inner surface of the reservoir portion 3. This characteristic will be explained below.

According to one exemplary embodiment, the inner surface of the annular body allows the passage of a rigid volume corresponding to 100% of the volume defined by the inner surface of the reservoir portion 3. This characteristic is understood to mean that the volume defined by the inner surface of the reservoir portion 3 corresponds substantially to the volume of the one-piece punch passing through the annular body to form the interior of the container body 2 during the pressing process. The inner surface of the annular body cannot be too large, either, because the annular body must formed as one piece with the reservoir portion 3. As a result, the inner surface of the annular body allows the passage of a rigid volume corresponding to at most 120% (preferably 110%) of the volume defined by the inner surface of the reservoir portion 3. In the case of a one-piece punch, the ratio is therefore between 100% and 120%.

However, the punch is not necessarily a single part, and may incorporate a mechanism movable between two positions to allow creating reliefs inside the reservoir portion 3. Even in these cases, however, the fixed body of the punch continues to constitute a substantial portion of the internal volume. It is considered that in most cases, the fixed body of the punch is inscribed within a homothety of 90% of the volume defined by the inner surface of the reservoir portion 3. Thus, in general for a direct pressing method, the ratio is between 90% and 120%.

As mentioned above, the pressing step may be followed by a blowing step which will slightly enlarge the internal volume of the reservoir portion 3 without substantially changing that of the annular body. Similarly, the reservoir portion 3 must remain integral with the annular body. Therefore, the internal volume is not greatly expanded during this step. The inner surface of the annular body allows the passage of a rigid volume corresponding to a homothety at a ratio of between 75% (preferably at least 80%) and 100% of the volume defined by the inner surface of the reservoir portion 3.

The bottle 1 comprises a closure system 60 hermetically assembled to the glass container body 2 so as to close the mouth of the glass container body.

As for the fluidtightness, the fluid to be contained in the bottle cannot flow out of the bottle at the connection between the glass container body 2 and the closure system 60 under normal conditions of use of the bottle 1, including conditions in which the bottle 1 is in an orientation different from the one in FIG. 1. The degree of sealing can be defined by a leak test. Such a leak test may, for example, include placing the filled bottle in a vacuum chamber in a predetermined orientation, for example with content in contact with the potential leakage area of the bottle. The ambient pressure in the chamber will gradually drop at a predetermined rate, the degree of sealing being defined by the ambient pressure at which content begins to leak from the bottle. Some embodiments disclosed herein may achieve a degree of sealing of −800 millibar (mbar), or even −950 mbar relative to atmospheric pressure.

The closure system 60 comprises a base 77, with a sealing interface 78 extending from the base 77, the assembly interface 4 of the mouth and the sealing interface 78 of the closure system cooperating for the hermetic assembly of the closure system 60 and the glass container body 2. A dispensing through-hole, and in particular each dispensing through-hole, is formed in the base 77.

In the example presented below, the closure system 60 comprises a sealing part 26 and a locking part 50 which interact as described below.

The bottle 1 comprises the sealing part 26. In the example shown, the sealing part 26 comprises a bottom 27 (FIG. 2) of a shape substantially complementary to that of the opening 14 of the container body 2. Thus, in the example, the bottom 27 of the sealing part 26 is of substantially rectangular shape.

The sealing part 26 has an through-hole 28. In the example, the hole 28 is substantially arranged along the Z axis of the container body 2, during assembly of the bottle 1. The hole 28 is adapted to receive a product dispensing device 30, for example a cap, a stopper, or a pump. In the example, the hole 28 receives a pump 30. In the following, we alternately use the terms “dispensing device” or “dispensing member” to refer to the system 30.

In the example, the hole 28 extends through a neck 79 of the sealing part 26 which projects from the upper surface 29 of said sealing part. The neck 79 comprises a cylindrical portion 31. An upper end 32 of the cylindrical portion 31 has a bead 33 onto which the pump 30 is crimped or snap-fitted (FIG. 2). The dispensing device 30 could be assembled to the sealing part 26 in any suitable manner.

The sealing part 26 also comprises a side wall 35 composed of a resiliently deformable material, such as polypropylene, that is suitable for an elastic fit and is chemically compatible with cosmetics. A lower surface of the bottom 27 may also be made of a material compatible with cosmetics. The side wall defines the entire periphery of the sealing part 26. The sealing part 26 may also be a single piece and then is made entirely of elastically deformable material. The sealing part 26 can thus deform slightly from its resting state to compensate for variations in the shape of the glass at the assembly interface 4. The side wall 35 extends from the upper surface 29. A groove 36 is provided between the side wall 35 and the bottom 27. The groove 36 has a shape that is substantially complementary to the shape of the edge portion 15 of the container body 2. The bottom 27 may itself comprise a peripheral wall 37 extending from the lower face 38 that is opposite to the upper face 29. The radially outer face 39 of the peripheral wall 37 has a shape complementary to the inner side surface 17 of the annular portion. The side wall 35 has a radially inner face 40 that is substantially complementary to the outer face 18 of the annular portion. The outer face 41 of wall 35 is opposite to the radially inner face 40. The outer face 41 of wall 35 is inscribed within the virtual cylindrical volume generated from the outer face 12 of the peripheral wall 6 of the container along the assembly axis. The side wall 35 has a continuous free edge 42. The edge 42 defines the edge of the side wall between its radially inner face 40 and its outer face 41. The term “continuous free edge” is understood to mean that the free edge 42 of the side wall 35 has no discontinuity in its material. The edge 42 is therefore unobstructed along the entire periphery of the side wall 35. However, note that alternatively the edge 42 could be discontinuous.

In the example, an outer surface of an upper end 43 (FIG. 2a) of the side wall 35 of the sealing part 26 has a slightly frustoconical profile, flared so that it widens towards the free edge 42.

The side wall 35 of the sealing part 26 is provided with an internal relief 44 (FIG. 2a) forming a means of assembly which fits elastically around the bead 16 of the container body 2. For example, the internal relief 44 is continuous along the entire periphery of the side wall 35.

The sealing part 26 further comprises the groove 36 (FIGS. 2 and 2a) formed in the bottom 27 of the sealing part. The groove 36 is defined by the bottom 27 on the one hand, and by the side wall 35 on the other.

The groove 36 is of a shape that is substantially complementary to that of the edge portion 15 of the container body 2, so as to accommodate the edge portion 15 of said container body therein. Thus, the groove 36 is of substantially rectangular shape. “Substantially rectangular shape” is understood to mean that in a cross-section along a plane normal to the assembly axis, the groove 36 has an annular shape corresponding to the annular shape of the edge portion 15 in the same plane. The annular shape has inner and outer surfaces in the shape of a rectangle with rounded corners.

In the example, the sealing part 26 comprises a gasket 45 (FIGS. 2 and 2a) suitable for forming a hermetic connection between the edge portion 15 of the container body 2 and the sealing part 26. The gasket 45 is formed of a deformable incompressible material. The gasket 45 is composed, for example, of an elastomer such as rubber, a thermoplastic elastomer, or a cellular material such as a polyurethane or polyethylene foam, particularly of high density.

The gasket 45 is of a shape substantially complementary to the edge portion 15 of the container body 2. Thus, the gasket 45 substantially forms a rectangle. As for the shape of the gasket, it has a ring shape of substantially constant cross-section along the peripheral direction of the ring, and a generatrix traveling along this periphery traces an approximately rectangular shape.

The groove 36 of the sealing part 26 is suitable for receiving the gasket 45. A cross-section of the gasket 45 is of substantially complementary shape to that of a profile of the groove 36, so that the gasket 45 mates with the walls of the groove 36. In particular, a shoulder 46 may be provided in the groove 36 so as to form a radial abutment surface receiving the gasket 45.

According to one embodiment of the invention, the gasket 45 is configured to form a hermetic connection between the sealing part 26 and a surface of the edge portion 15 of the container body 2 that is selected from among the bead 16, the upper surface 25, and an inner side surface 17 (FIG. 2a).

In this case, the gasket 45 may, for example, be in the form of a band.

According to a preferred embodiment of the invention, the gasket 45 is configured to form a hermetic connection between the sealing part 26 and at least two surfaces of the edge portion 15 of the container body 2 that are selected from among the bead 16, the upper surface 25, and the inner side surface 17.

In the example, the gasket 45 has a substantially L-shaped cross-section, to mate with the upper surface 25 and the inner side surface 17 of the edge portion 15 of the container body 2. Such a cross-section could also be applicable to the case where the gasket 45 is intended to mate with the upper surface 25 and the bead 16 of the edge portion 15 of the container body 2.

Alternatively, the two portions of the L are not completely joined along the periphery of the gasket, or may not be joined at all.

The gasket 45 may also have a substantially triangular cross-section so that one face of said gasket is compressed against an edge 47, 47 of the edge portion 15 of the container body 2, formed between the upper surface 25 and the bead 16 or the inner side surface 17, respectively.

A gasket 45 having a substantially U-shaped cross-section would also be possible, enabling it to mate with the upper surface 25, the inner side surface 17, and the bead 16.

According to one embodiment of the invention, the gasket 45 comprises at least one protruding element 48, 49 or sealing lip adapted to form a sealing line against the edge portion 15 of the container body 2. Preferably, at least one sealing lip 48, 49 has a tapered shape or has an outer surface with a partially circular cross-section.

In the example, the gasket 45 comprises two sealing lips 48, 49 (FIG. 2a), each capable of forming a sealing line against the inner side surface 17 of the edge portion 15 of the container body 2.

A number of sealing lips greater than two may also be considered, particularly when the gasket 45 is configured so as to form a sealed connection between the sealing part 26 and only one among the surfaces 16, 25, or 17 of the edge portion 15 of the container body 2.

When at least two sealing lips 48, 49 are used, they may, depending on the configuration of the gasket 45, be arranged so that each forms a sealing line against multiple surfaces 16, 25, 17 forming the edge portion 15 of the container body 2.

Alternatively, the sealing part 26 and the gasket 45 are one part and are formed of the same material. This applies in particular to the case of polyethylene, or high density polyethylene. The characteristics of the gasket 45 and the embodiments detailed above can be adapted to the sealing part 26 alone. For example, the sealing part 26 may form a hermetic connection with one, two, or three surfaces 16, 25, 17 of the edge portion 15 of the container body 2. The sealing part 26 may also comprise one or more protruding elements 48, 49, each suitable for forming a sealing line against the edge portion 15 of the container body 2.

Alternatively, the sealing part has a face suitable for being compressed against an edge of the edge portion 15 of the container body 2, formed between an upper surface 25 and an inner side surface 17 or the bead 16.

Thus, the bottom 27 forms a base 82 from which extends the sealing interface 83 on the one hand and the neck 79 on the other hand. The base 82 may provide an additional function besides the simple mechanical function of connecting the neck 70 to the sealing interface, in which case it is a functional base.

The bottle 1 further comprises a locking part 50 suitable for insertion around the side walls 35 of the sealing part 26. It is understood here that the sealing part 26 is suitable for insertion into the locking part 50, with the locking part 50 around the side wall or walls of the sealing part 26. In the example, the slightly tapered profile of the outer surface 51 of the upper end 43 of the side walls 35 of the sealing part 26 is intended to facilitate assembly of the locking part 50 to the sealing part 26.

The locking part 50 consists of a material that has little elastic deformability compared to the material of the sealing part 26. Such a material may be, for example, rigid plastic or metal, or be stiffened by a surface treatment such as galvanizing or lacquering.

The locking part 50 comprises side walls 52 suitable for surrounding the side walls 35 of the sealing part 26. This example is again given for the embodiment having a substantially rectangular geometry, provided by way of example. It is understood that in other embodiments, the locking part 50 has at least one side wall 52 suitable for surrounding the side wall 35 of the sealing part 26. The following description continues to refer to the specific geometry of the embodiment shown, but can be adapted to any other embodiment. The side walls 52 of the locking part 50 are configured to form a tight coupling with the sealing part 26, in particular with the side wall or walls 35 thereof, when the side walls 52 of the locking part 50 are inserted around the side walls 35 of the sealing part 26.

The locking part 50 may comprise a bottom 53, and the side walls 52 extend from the bottom.

The side walls 53 of the locking part 50 are substantially parallel to the side walls 35 of the sealing part 26. In the example, the side walls 53 of the locking part 50 are substantially parallel to a lower end of the side walls 35 of the sealing part 26. Thus, insertion of the side walls 53 of the locking part 50 around the side walls 35 of the sealing part 26 allows locking the sealing part 26 around the bead 16 of the container body 2 without causing elastic deformation of said side walls 35 of the sealing part 26.

In the example, the locking part 50 also comprises a bottom 53 (FIGS. 2 and 2a) equipped with a through-hole 54 suitable for receiving a dispensing member such as a pump 30. In practice, as in the example shown, the hole 54 accommodates the cylindrical portion 31 onto which the dispensing member is fixed. The hole 54 thus forms an opening providing access to the product contained inside the packaging device. The hole 54 of the locking part 50 is configured to be substantially coaxial with the hole 28 of the sealing part 26 during assembly of the bottle 1. The through-hole 54 of the locking part 50 and the through-hole 28 of the sealing part 26 thus together form a hole 80 in the sealing system 60. As a result, the dispensing member 30 can extend through both the locking part 50 and the sealing part 26 to place the inside of the bottle in communication with the outside. In other words, the dispensing member can extend through the closure system 60 in order to place the inside of the bottle in communication with the outside.

In the example, axial retention of the locking part 50 on the sealing part 26 is provided. For example, the locking part 50 is snap-fitted to the sealing part 26. For example, a free edge 55 of the side walls 52 of the locking part 50 is provided with an internal relief 56 (FIG. 2a). The internal relief 56 of the locking part 50 is small in size compared to the internal relief 44 of the sealing part 26. The internal relief 56 of the locking part 50 is suitable for abutment against the free edge 42 of the sealing part 26. For this, one will note that in the example shown, when the sealing part 26 is assembled to the container body 2, a gap 57 is defined between the free edge 42 of the side wall 35 of the sealing part 26 and the shoulder 23 of the container body 2. The internal relief 56 is received in this gap 57 when in the assembled position of the locking part 50 with the sealing part 26.

The side wall 52 of the locking part 50 comprises an inner face 58 and an opposite outer face 59. The free edge 55 of the side wall 52 connects the inner 58 and outer 59 faces. The inner face 58 has a geometry complementary to that of the outer face 41 of the side wall 35 of the sealing part 26. Outer face 59 has any suitable shape. Note that in the embodiment presented, the free edge 55 comes into close contact with the shoulder 23 of the container body 2. This occurs along the entire periphery of the container body 2. “Close contact” is understood to mean that these two surfaces are in contact, or are spaced apart by a distance that is insignificant at the scale of the product (in particular so that a tool of the thickness of a knife blade or some comparable tool cannot be slid between these surfaces). Furthermore, and independently, in this embodiment outer face 59 is continuous with the outer face 12 of the container body 2. This continuity may, as shown, have no shoulder or curvature.

The locking part 50 thus forms an outer cover 73 for the bottle which covers and hides the sealing part 26.

The components likely to come in contact with the content (in particular the sealing part 26 and the gasket 45) are chosen to satisfy requirements of compatibility (the product to be contained in the bottle does not cause deterioration of the component) and neutrality (the component does not release any compounds into the liquid product in undesirable proportions). These requirements influence the materials used for these components or their method of manufacture. The requirements may depend on the content.

As shown in FIG. 7a, the dispensing member 30 comprises a product outlet 67, a tube 68 adapted to guide the product which may be contained in the receptacle to the product outlet 67, and an actuating member 69 which can be actuated by a user to control release of the product through the product outlet 67. The actuating member 69 comprises a base 70 fixed to the closure system, and a member 71 that is movable relative to the base 70 and comprising a user-accessible actuation region 72 which can be actuated to control the release of product, the movable member providing the product outlet 67.

The bottle thus comprises a very rigid glass container body which may vary slightly in shape, a flexible sealing part able to deform elastically to compensate for variations between different glass container bodies from the same production line, and a rigid locking part (of a stiffness between that of the glass and the sealing part) to keep the flexible sealing part and the glass container body together. Where appropriate, a highly deformable gasket further improves the interface between the glass and the flexible sealing part.

The method for assembling such a bottle 1 takes place in the following steps.

In the example, the gasket 45 is initially applied against the sealing part 26. Specifically, the gasket 45 is placed in the groove 36 formed in the sealing part 26. According to one embodiment of the invention, the gasket 45 may be cut or molded and then applied against the sealing part 26, or even overmolded directly to the sealing part 26.

The sealing part 26 is then assembled to the container body 2 by elastically fitting the side walls 35 around the bead 16, by translational movement of the bead 16 toward the bottom 27 of the sealing part 26. The container body 2 and the sealing part 26 are moved relative to one another in an assembly direction. In the example, this assembly direction is a translational direction. For example, it is coincident with the Z axis. The continuous free edge 42 of the side walls 35 of the sealing part 26, and in particular the continuous relief 44, forces the side walls to deform radially during the passage of the internal relief 44 over the bead 16, then they return to their non-deformed or slightly deformed state when the internal relief 44 lodges under the bead 16. The internal relief 44 of the sealing part 26 then abuts against the bead 16, thereby preventing detachment of the sealing part 26 and container body 2. The elastic interlocking of the side walls 35 of the sealing part 26 around the bead 16 is therefore achieved prior to insertion of the locking part 50 around the side walls 35. Note that this embodiment has the advantage of the side wall 35 being substantially in the rest state when the bottle is assembled, and in any case the natural elasticity of the materials of the side wall 35 biases the side wall 35 to a state in which it is fitted onto the container and cooperates with it mechanically.

The elastic interlocking of the side walls 35 around the bead 16 ensures hermetic contact between the gasket 45 and the edge portion 15 of the container body 2 on the one hand, and the gasket 45 and the sealing part 26 on the other hand, by compression of the gasket. In the example, the hermetic contact between the gasket 45 and the edge portion 15 is achieved in particular at the upper surface 25 of the edge portion 15, with the rounded edge 24 of the edge portion 15, and at the inner side surface 17, in particular by means of sealing lips 48, 49 which each form a sealing line.

In this configuration, compression of the gasket 45 between the edge portion 15 of the container body 2 and the sealing part 26 transmits a force to the sealing part 26 along the Z axis that tends to uncouple the side walls 35 of the sealing part 26 from the bead 16 of the container body 2.

According to a variant, in which the sealing part 26 and the gasket 45 are one part formed of the same material, the elastic fitting of the side walls 35 around the bead 16 ensures hermetic contact between the sealing part 26 and the edge portion 15 of the container body 2, by compression of said sealing part. The edge portion 15 of the container body 2 transmits a force to the sealing part 26 along the Z axis that tends to uncouple the side walls 35 of the sealing part 26 from the bead 16 of the container body 2.

Next, the locking part 50 is forcibly inserted around the side walls 35 of the sealing part 26. This insertion is achieved by a relative translational movement along the assembly direction of the locking part 50 and of the assembly of container body 2 and sealing part 26 assembled together. The slightly tapered profile 51 of the upper end 43 of the side walls 35 of the sealing part 26 aid the insertion of the side walls 52 of the locking part 50 around said side walls of the sealing part 26. The side walls 52 of the locking part 50 slide along the side walls 35 of the sealing part 26, without causing any substantial elastic deformation of said side walls of the sealing part 26. The side walls 52 of the locking part 50 retain the side walls 35 of the sealing part 26 around the bead 16 of the container body 2, preventing the side walls 35 of the sealing part 26 from releasing from the bead 16. The locking part 50 thus counteracts the axial force transmitted to the sealing part 26 by the compression of the gasket 45. Assembly of the packaging device is intended to be definitive, meaning that neither the sealing part nor the locking part are designed to be removed from the container during normal use of the packaging device.

In the example, the container body 2 is then filled with a cosmetic product. This product will thus be in direct contact with the glass container body and the sealing part 26. Next, the dispensing member, such as the pump 30, is inserted into the hole 80, in particular through holes 28, 54 of the sealing part 26 and locking part 50, then secured, for example crimped, screwed, or snap-fitted into place around the bead 33 of the cylindrical portion 31 of said sealing part. One will note in particular that the dispensing member here is assembled to the sealing part 26, the cylindrical portion 31 of said part 26 forming an attachment tube extending through the hole 54 of the locking part 50. The dispensing member is hermetically assembled to the sealing part 26.

Alternatively, the dispensing member may be assembled to the locking part 50. The dispensing member may comprise a dip tube providing access to the product in the bottom of the container body 2.

Access to the product inside the packaging device is only possible via the dispensing member. The locking part 50 is designed to be permanently assembled to the container body 2 in a tamper-proof manner. This tamper-proofing only relates to opening means that are directly accessible to the user of the packaging device, for example a bottle opener or a knife blade. Although the tamper-proofing is made possible in particular by the absence of attackable contours or reliefs at the interface between the free edge 55 of the locking part 50 and the shoulder 23, such an absence is not absolutely necessary to an implementation of the invention. This absence of attackable contours or reliefs, however, also prevents the deposit of harmful materials (dust, etc.) at that location.

Where appropriate, the locking part 50 may be adhered to the sealing part 26 or to the container body 2, for example by gluing at the free edge 55.

Alternatively, the elastic fitting of the side wall 35 of the sealing part around the bead is caused by forced insertion of the locking part 50 around the side wall 35 of the sealing part. In this example, the sealing part is assembled to the container body 2 with a gap between the relief 44 and the bead 16. Then the locking part deforms the side wall 35 to generate the elastic fitting of the side wall 35 of the sealing part around the bead.

Such a method of assembling a bottle offers the advantage of not being limited to bottles where the glass container body 2 has a circular opening. The method described above thus allows a wide variety of shapes for the glass container body 2, and therefore a wide variety of shapes for the bottle as a whole. It is particularly suitable for container bodies 2 where the inner surface and/or virtual geometric surface 20 of the annular portion has a non-cylindrical rotational symmetry. For such geometries, the sealing is very difficult to guarantee due to the peripheral non-uniformity of the forces applied to the gasket. This is especially true because the dimensions of the areas to be sealed are large, as in the present case where a dimension of the container opening is of the same order as the dimensions of the container body 2. Tests have shown that the present invention provides excellent levels of sealing while allowing easy assembly.

The above embodiment provides a detailed illustration of the case where the reservoir portion 3 of the container body 2 has a substantially rectangular shape, and where the assembly interface 4 has a substantially rectangular shape. There are many variants. In particular, these shapes are not necessarily closely correlated. These shapes may even be substantially independent of one another. For the reservoir portion 3, its external shape is substantially independent of its internal shape. For the assembly interface, its internal and external shapes may be highly dependent on one another. In particular, there is a constant thickness of the material along the periphery of the assembly interface 4. Alternatively, the thickness of the material along the periphery of the assembly interface 4 is dependent on the local curvature. A gradual transition is provided between two portions that are inclined relative to one another (in FIG. 1 one can see that the curvature of the rounded edge of the assembly interface is much less than that of the reservoir portion 3).

FIG. 3a shows a front view of a bottle 1 according to a first embodiment of the invention. The embodiment of FIG. 3a comprises a glass container body 2, with a closure system 60 assembled to the glass container body and sealing the glass container body 2. For a practical implementation, one may refer for example to the above description with reference to FIGS. 1 to 2b.

The closure system 60 and the dispensing system 62 have a dual functional dispensing interaction.

In this embodiment, the bottle has a product dispensing system 62 comprising a first dispensing member 30 and a second dispensing member 130. In the following description, generally a second object corresponding to a first object has the same reference number as the first object but to which 100 is added.

The first and second dispensing members 30, 130 are independent from one another, in other words each can be actuated by a user independently of the other in order to dispense a product contained in the bottle 1. In the present embodiment, the bottle 1 defines a single receptacle for a product, and therefore contains a single product to be dispensed. A “product to be dispensed” considered to be single is a product which may contain a mixture of several chemical compounds in the bottle, but of a composition that is appropriately controlled, for example homogeneous, for the intended application. The first and second dispensing members 30, 130 are, for example, identical.

For a practical implementation, the basic example presented above in relation to FIGS. 1 to 2b can be modified to provide two parallel necks (identical in this embodiment) in the sealing part 26, instead of neck 79. In the locking part 50, two holes are provided, each allowing the passage of a respective neck, instead of hole 54 through which the cylindrical portion 31 passes. Alternatively, there may be a single hole 54 shaped to allow the passage of both necks. Each dispensing member 30, 130 is assembled onto a respective neck.

In a variant of the above embodiment, as shown in FIG. 3b, one does not necessarily use two identical or similar dispensing members. A bottle 1 may be provided having two different dispensing members. The other characteristics of the bottle 1 according to this embodiment are those of the embodiment of FIG. 3a. The two different dispensing members 30, 130 differ, for example, in the dispensing technology (also called “dispensing mode”). For example, the first dispensing member 30 is a pump. The second dispensing member 130 is an applicator comprising a handle portion 63 and an applicator portion 34 extending inside the bottle. Dispensing member 130 differs from dispensing member 30 in that dispensing member 30 is fixedly held (although its actuation is possible) on the container body 2, while dispensing member 130 is detachably assembled to the glass container body. Dispensing member 130 may have an assembled configuration, represented in FIG. 3b, in which it hermetically plugs hole 154, and an application configuration in which it is separated from the container body 2. In the application configuration, the applicator portion 34, bearing the product contained in the bottle 1, can be applied to a user. They therefore differ in the type of dispensing (contact or from a distance).

The second dispensing member 130 may be supported in any suitable manner by the closure system 60. It may be arranged for example that it extends into a neck 79 of the sealing part 26, as in the previous embodiment, except that instead of crimping it on, it is simply held in place by mechanical engagement, for example by abutment and/or friction. Such retention does not necessarily require a neck 79 in the sealing part 26, but alternatively may require a simple abutment surface. As is schematically represented for example in FIG. 6, the second hole 180 has for example an inset frustoconical shape, and the second dispensing member 130 has a portion 181 of complementary shape, defining a lower stop for the second dispensing member.

Another possibility for the embodiment with different first and second dispensing members 30, 130 is that they differ in the amount of product dispensed. In particular, it is provided to use a first and a second dispensing member 30, 130 which both use the same dispensing mode and the same dispensing type, but differ in the volume dispensed. “Differ” is understood by the skilled person to mean that, regardless of the slight variations normally encountered for this type of product, the amounts dispensed are made different by the intended design differences between the dispensing members. In the case where two pumps are used for example, the two pumps may dispense different flow volumes. In the case where two applicators are used, two applicators may be provided for example that comprise different reservoir volumes.

Such an embodiment gives the user different options for applying the cosmetic product, depending on the application desired by the user. The intended use may, for example, depend on the body area where the product is to be applied and/or the occasion for which the cosmetic product is to be applied.

Thus, depending on the variants, the dispensing members 30, 130 differ in one or more of the following:
the volume dispensed by the dispensing,
the dispensing mode, where “mode” refers to the dispensing technology, in particular spraying (application without contact—conveyed by gas) or application by contact of a liquid product (poured) or solid product (in this case, the application is by contact, using a brush, stick, spatula, etc.).

In the particular case of application by spraying, the spraying may also be characterized by different parameters, namely one or more of the following:
the type of dispensing, which concerns the ability to have the droplets spaced closer together or further apart, or even to form a continuous jet,
the size distribution of the sprayed droplets,
the spatial three-dimensional shape of the dispensed volume (shape and cross-section of the cone of spray) between the bottle and the user.

In the particular case of application by contact, the contact may also be characterized by different parameters, namely one or more of the following:
the type of dispensing, according to whether the product is applied by pouring or with an applicator, and in the latter case the type of applicator (brush, stick, spatula, etc.)
the three-dimensional shape of the dispensed volume on the user (shape and cross-section of the pattern applied by the applicator).

According to a third embodiment, as represented in FIG. 3c, any of the alternatives presented above in relation to FIGS. 3a and 3b may be implemented with a bottle comprising two receptacles 64, 164 that are sealed relative to one another. For the practical implementation, the glass container body 2 has a shape suitable for defining two hermetically sealed containers when it is assembled to the closure system 60. The pressing method described above allows creating a glass container body 2 comprising two different portions separated by a separating portion 65. One simply needs to provide a suitable shape for the forming punch. The separating portion 65 interacts with the closure system 60 to ensure the seal between the two receptacles. The shape of the gasket 45 is adapted for example so that it is compressed between the separating portion 65 and its counterpart.

According to the example shown in FIG. 3c, the dispensing system comprises a first dispensing member 30 and a second dispensing member 130, each in contact with their respective receptacle 64, 164. Two identical dispensing members are used for example. Two independent dispensing members are used for example. In an exemplary embodiment, the bottle 1 comprises two different products, respectively in the first and second receptacles 64, 164. The bottle which has just been described enables the user to apply one and/or the other of the two products independently. A user may, for example, wish to apply one of the products to a particular body area, and the other product to another body area. Alternatively, the user may wish to apply one of the products for certain occasions, and the other product for other occasions. For example, when the product is a personal care product, one product is for daytime use and one product is for nighttime use.

According to various examples, the first and second products differ in at least one of the following characteristics:
chemical composition,
density,
dilution factor,
viscosity.

In another alternative, the bottle 1 allows the user to create the product to be applied. By dispensing both the first product and the second product in proportions determined by his or her usage of the two dispensing members, the user can thus create a unique product to be applied. By changing these proportions, he or she can create a wide variety of unique products to be applied.

In this embodiment, it may be provided that the two products have a certain compatibility. In this case, a bottle is provided that permits all the above possibilities with products specifically designed for this implementation (the implementation described above is primarily prevented today by the possible chemical incompatibility of two cosmetic products available in separate packaging). Thus, the two products will be specifically designed to be mixed in varying proportions. It is also possible that both products contain the same chemical composition, but at a different concentration or with different proportions of their chemical components.

In the above example, two identical dispensing members are represented in FIG. 3c. However, two different dispensing members could be provided as explained above in relation to FIG. 3b.

In the above example, two receptacles of identical shape and volume are represented in FIG. 3c. However, two different receptacles could be provided.

For example, the two receptacles have one or more (if they are compatible) of the following arrangements:
an identical external shape,
an external shape that is symmetrical to one another,
an external shape that is different from one another,
an external shape that is asymmetrical to one another,
an identical internal shape,
an internal shape that is symmetrical to one another,
an internal shape that is different from one another,
an internal shape that is asymmetrical to one another,
an identical volume plus or minus 10%,
a volume that differs by at least 10%,
a volume that differs by at least 50%,
identical external decoration,
different external decoration,
identical internal decoration,
different internal decoration.

Thus, to characterize, a bottle could be provided comprising a glass container body 2 having the external shape of a truncated sphere, forming a translucent first receptacle of large volume having an asymmetric internal shape, containing a perfume applied by a pump, and an opaque second receptacle of small volume next to the first receptacle, having an internal shape of a circular cylinder, which can be applied by an applicator.

As can be seen in FIG. 3c, decorative objects 88, 89 may be provided in each of the receptacles 64, 164. In particular, decorative objects may be assembled to the closure system 60. This assembly may be a mechanical assembly, or the objects 88, 89 may be integral with the closure system 60. The closure system 60 thus has a functional decorative interaction with the dispensing system in that it provides a seat for the attachment of decorative objects without interfering with the dispensing of product. In particular, the decorative objects 88, 89 may be large in size, smaller than the mouth 61 but larger than the dispensing hole 28. In alternative embodiments with a single receptacle, the above description can be transposed to a single decorative object.

The embodiment of FIG. 3d is similar to the embodiment of FIG. 3c, except that the two receptacles are not necessarily defined by two glass containers side by side in the container body 2. In this embodiment, a casing is used, for example of plastic, to define the two receptacles. The casing 86 is, for example, assembled by ultrasonic welding, heat sealing, or continuous bonding along a closed path on the lower face of the closure system 60. For example, a plastic casing is provided, but alternatively a casing of another suitable material may be provided, metal or glass for example, as long as can be hermetically assembled to the closure system 60. In this embodiment, the two receptacles are nested one inside the other.

According to a fifth embodiment, represented in FIG. 3e, a bottle 1 is again used that comprises two hermetically sealed receptacles that are side by side. The dispensing system 62 differs from the one in FIG. 3c in that it offers combined access to both receptacles. In other words, access to the two receptacles can no longer be independent as in the previous embodiment, but must be dependent.

For the dispensing system 62, a dispensing system is provided for example as described above in relation to FIG. 3c, where the product dispensing devices 30, 130 are integrally secured to allow their common actuation. A cap may be provided for example that covers the actuation portion of the two product delivery devices, and defines the two product outlets.

Such a system allows dispensing a cosmetic product that is created immediately for the desired occasion at the time of dispensing, from components contained in separate receptacles. It thus avoids long-term storage in a single receptacle of chemical compounds that are necessary to achieve the cosmetic effect but are not necessarily suitable for storing together over the long term.

This implementation of a common dispensing system is not limited solely to the container embodiment of FIG. 3c, but is compatible with certain other container embodiments described above.

In a sixth embodiment, represented in FIG. 3f, this embodiment incorporates the dispensing principles of the embodiment of FIG. 3, except that the bottle 1 is modified. Instead of creating the bottle with a single glass container body 2, the bottle is created by means of two glass container bodies 2, 102 that are distinct from one another, joined together by a sealing connection system 87. In this embodiment, depending on the implementation of the sealing connection system, there are alternatively one or two sealed receptacles in the bottle 1.

The embodiments described above illustrate various examples of a dual functional dispensing interaction between the closure system and the dispensing system, but, if desired, one could have a dispensing interaction with more than two functions, for example three.

In other aspects, the closure system 60 and the dispensing system 62 cooperate to provide functional dispensing interaction that provides protection. In particular, it protects against accidental actuation of the dispensing system. In particular, the closure system 60 defines a housing 84 for the dispensing system 62. “Housing” is understood to mean that the closure system at least partially surrounds a portion of the dispensing system. For example, the dispensing system is partially inset into the closure system 60. In the case where the dispensing system comprises a pump, a portion of the dispensing system 62 must be clear of the closure system 60: the product outlet 67, because the product must of course be dispensed in an area that has no obstacles between the bottle 1 and the user. The actuation region 72, which must be accessible to at least one of the user's fingers, may also be clear of the closure system 60.

The closure system 60 has a portion serving to seal the glass container body 2. Another portion of the closure system 60 is used for assembling the dispensing system 62. A third portion of the closure system 60 is used to define a container portion. This portion may be of sufficient volume to contain a substantial proportion of the content, for example at least 10% or even at least 30% of the content. The portions of the closure system 60, which are not used either for sealing or for assembly of the dispensing system, may be used to fulfill additional functions as long as they do not prevent carrying out the two functions mentioned above. In the example of FIG. 4a, the outer cover 73 of the closure system 60 has a shape defining a housing for the dispensing system 72. The cover 73 defines contours providing a recess 74 where the dispensing system 62 is received. This recess 74 comprises at least one side wall 75 which partially surrounds the dispensing system 62. In particular, for example, a side wall 75 is provided on each side of the dispensing system 62. In this case, the two side walls 75, which are parallel, define a groove in the cover 73, where the dispensing system 62 is received. As can be seen in FIG. 4b, a transverse side wall 75 may extend between the two side walls 75 mentioned above, and be arranged facing the dispensing system 62 on the side opposite the product outlet 67. Any desired configuration may be used as a variant of these side walls 75, 75, for example a partially cylindrical side wall that is rotationally symmetrical and that surrounds the dispensing system 62.

Such an embodiment prevents actuation of the dispensing system without requiring an additional removable cap attached to the bottle. Moreover, this embodiment allows the bottle to have a larger useful volume. It is sufficient that the sealing part 26 conforms to the geometry of the locking part 50.

In the example shown, the closure system represents about 15% of the volume of the bottle. Alternatively, the closure system could represent an even greater volume of the bottle, typically about 50% for example.

According to another embodiment, represented in FIG. 5a, a functional dispensing interaction is provided with inclination between the dispensing system and the closure system. In particular, the sealing part 26 may be modified so that the axis of the neck 31 has an inclination α relative to the sealing midplane. The sealing midplane is the midplane of the points of contact forming a seal between the sealing part 26 and the glass container body 2. The inclination is, for example, no more than approximately 80°, or even no more than approximately 45° for example. The locking part 50 may be modified to ensure that it can be assembled onto the sealing part 26 in the assembly direction.

Such an inclination can improve the dispensing of product in certain areas that are difficult to access. Such an inclination, combined for example with a particular shape of the locking part 50, can improve the grip on the bottle. Independently, one will note that in FIG. 5a, the cover is not necessarily flat but may have any suitable shape. In particular, it may be arranged that a longitudinal axis of the dispensing member is oriented at an angle of at least 15° relative to a normal to the cover.

According to another embodiment, represented in FIGS. 5a and 5b, a functional dispensing interaction with mobility between the dispensing system and the closure system is provided. A product dispensing device 30 is provided that is movable between a first position and a second position. It is also arranged that the product dispensing device 30 can be stably retained in at least one of these two positions, in particular in these two positions, or even in one or more intermediate positions between these two positions. An embodiment of the types described above is used for example, where the closure system 60 provides a sealing function on the glass container body 2. Referring to the architecture of the bottle as described in relation to FIG. 1, the product dispensing device 30 is assembled onto a neck 79 of the closure system 60 which comprises mechanical parts, and not onto a glass neck. A mechanism is provided for hinging the upper part of the neck on its base. The hinge mechanism contributes to the stable retention of the dispensing device 30 in one and/or the other of the desired positions. Such a hinge mechanism may be provided by any suitable means. For example, the neck comprises a flexible portion that hinges its upper part relative to its base in at least one, two, or even three stable positions. Alternatively, the connection between the neck 79 and its base may be provided by an alternative system. The cover 73 has a slot 76 allowing this movement of the product dispensing device 30 between its two positions. The dispensing member 30 is manually movable between the various positions along an axis transverse to the longitudinal axis of the dispensing member. In some variants, the degree of freedom of movement may alternatively be a translation along the longitudinal axis of the dispensing member, or a rotation about an axis in a plane normal to the longitudinal axis of the dispensing member, for example.

The longitudinal axis of the dispensing member is a functional axis thereof, along or around which the dispensing member can be actuated or moved to dispense the product. Depending on the case, such an arrangement may allow a preferred actuation or a particular dispensing of the product.

Thus, in the embodiments described above, the sealing part 26 comprises a portion for assembly to a dispensing member, a portion for interfacing with a glass container body in order to seal the bottle permanently closed, and an intermediate portion which connects the assembly portion and the interface portion.

The intermediate portion may be functional. For example, it allows the dispensing member to move between two positions relative to the glass container body. For example, it has a shape allowing the dispensing member to be inclined relative to a conventional implementation in bottles having a glass body. As a further example, it allows encapsulating the dispensing member to protect it from inadvertent actuation. It increases the volume of the bottle without adding glass. It allows having a second dispensing member. It allows providing a seat for a decorative object of large dimensions. Most of these different functions can be combined.

The above embodiments provide different alternative implementations of the functional dispensing interaction between the closure system and the dispensing system. These alternatives were presented in a context where the bottle comprises a closure system comprising two separate parts, a sealing part 26 and a locking part 50. In this case, the through-hole in each of these two parts are superposed one atop the other to form the dispensing through-hole in the closure system.

Alternatively, as represented in FIG. 8, it is not necessarily the sealing part 26 which provides the portion for assembly to the dispensing member. In this embodiment, the locking part 50 may provide the portion for assembly to the dispensing member. For example, a neck is created directly in the locking part 50. The sealing part 26 is dedicated to the sealing function. For example, the sealing part 26 comprises only the peripheral portion cooperating with the glass container body, but not the central portion. In this case, the functional intermediate portion is provided in the locking part 50. In addition, the sealing part 26 ensures the seal with the locking part 50.

Alternatively, one could provide a closure system comprising a single part, when this part alone can implement the sealing function. In such a case, it is this single part that implements the additional function described above.

In general, it is understood that the closure system comprises a portion for assembly to a dispensing member, a portion for interfacing with a glass container body in order to seal the bottle permanently closed, and an intermediate portion that connects the assembly portion and the interface portion, the intermediate portion being functional regardless of whether the closure system is implemented with one, two, or more elements.

Various examples of a functional dispensing interaction with dual dispensing, protection, mobility, or decoration between the closure system and the dispensing system were described above. In other embodiments, some of these arrangements may be combined when such is possible. One could, for example, provide a bottle having a functional interaction with dual dispensing, where one and/or the other of the dispensing members cooperate with the closure system to present a functional dispensing interaction with inclination, protection against accidental actuation of the dispensing member, and/or mobility, and/or decoration.

According to a second invention, a bottle is provided comprising:
a glass container body 2 comprising a mouth 61 of circular shape,
a closure system 60 hermetically assembled to the glass container body so as to close the mouth 61, the closure system comprising an outer cover 73, the closure system 60 comprising a dispensing through-hole 80,
a product dispensing system 62 comprising at least one dispensing member 30 assembled so as to provide access to a product that may be contained in the bottle, through the dispensing through-hole 80,
   wherein the closure system 60 and the dispensing system 62 cooperate to further provide a functional dispensing interaction.

According to some aspects of this second invention, one or more of the following arrangements may be provided:
the closure system 60 has a neck 79 extending outwardly relative to the outer cover 73, the dispensing through-hole 80 is created at least partially in the neck 79, and the dispensing member 30 is assembled onto the neck 79 of the closure system 60;
the dispensing through-hole 80 is a first dispensing through-hole, the dispensing member 30 is a first dispensing member, the closure system 60 comprises a second dispensing through-hole 180, and the product dispensing system 62 comprises a second dispensing member 130 assembled to the closure system 60, to provide access to a product that may be contained in the bottle, through the second dispensing through-hole 180;
the first and second dispensing members 30, 130 differ in at least one characteristic selected from the following:
   the volume dispensed by the dispensing,
   the dispensing mode,
   the dispensing type,
   in the case of dispensing by spraying, the size distribution of the sprayed droplets,
   In the case of dispensing by spraying, the spatial three-dimensional shape of the dispensed volume;
the closure system 60 is assembled to the glass container body 2 so as to define first and second receptacles 64, 164 that are sealed relative to one another, and the first dispensing member 30 is adapted to provide access to a product contained in the first receptacle 64, and the second dispensing member 130 is adapted to provide access to a product contained in the second receptacle 164;
the first and second receptacles 64, 164 have one or more of the following characteristics:
   an identical external shape,
   an external shape that is symmetrical to one another,
   an external shape that is different from one another,
   an external shape that is asymmetrical to one another,
   an identical internal shape,
   an internal shape that is symmetrical to one another,
   an internal shape that is different from one another,
   an internal shape that is asymmetrical to one another,
   an identical volume plus or minus 10%,
   a volume that differs by at least 10%,
   a volume that differs by at least 50%,
   identical external decoration,
   different external decoration,
   identical internal decoration,
   different internal decoration.
the two receptacles 64, 164 are hermetically defined relative to one another by a casing 86 attached to the closure system 60;
the mouth 61 comprises an assembly interface 4, the closure system 60 comprises a base 77, a sealing interface 78 extending from the base 77, the assembly interface 4 of the mouth 61 and the sealing interface 78 of the closure system 60 cooperating for a hermetic assembly of the closure system 60 and the glass container body 2, at least one dispensing through-hole 80 and in particular each dispensing through-hole 80, 180 being formed in the base 77;
the base 77 forms the outer cover 73;
the closure system 60 comprises a sealing part 26 and a locking part 50 covering the sealing system, the locking part 50 forming the cover 73, the at least one dispensing through-hole 80, 180 being formed by the superposition of a through-hole 54 in the locking part and a through-hole 28 in the sealing part 26, through which the dispensing member 30 extends;
the locking part 50 clasps the sealing part 26 to ensure a hermetic assembly between the closure system 60 and the glass container body 2;
the neck 79 is provided by a plastic part;
the sealing part 26 provides the neck 79;
the cover 73 forms a housing 84 for the dispensing member 30, the closure system 60 and the dispensing system 62 cooperating to provide a functional dispensing interaction that protects against accidental actuation of the dispensing member;
the cover 73 has at least one wall 75 partially surrounding the dispensing member 30 and extending about a longitudinal axis of the dispensing member 30;
the cover 73 further has a wall 75 extending transversely to the longitudinal axis of the dispensing member 30;
a longitudinal axis of the dispensing member 30 is oriented at an angle of at least 15° relative to a normal to the cover 73;
the dispensing member 30 is mounted so as to be movable relative to the cover 73 between a first position and a second position with a first degree of freedom, the closure system 60 comprising a system for stably retaining the dispensing member 30 relative to the cover 73 in at least one of the first and second positions, and in particular in both the first and second positions, the closure system 60 and the dispensing system 62 cooperating to provide a functional dispensing interaction with mobility;
the system for stably retaining the dispensing member 30 relative to the cover 73 is suitable for stably retaining the dispensing member 30 relative to the cover 73 at least in one intermediate position between the first and second positions;
the first degree of freedom is a translation along the longitudinal axis of the dispensing member 30;
the first degree of freedom is a rotation about an axis of a plane normal to the longitudinal axis of the dispensing member 30;
the closure system 60 is hermetically assembled to the glass container body 2 so as to close the mouth 61 permanently;
the glass container body 2 is a first glass container body, the bottle further comprising a second glass container body 102 secured to the first glass container body 2 by a sealing connection system 87;
the closure system 60 and the dispensing system 62 cooperate to provide a functional dispensing interaction with inclination between the dispensing system and the closure system;
the closure system 60 and the dispensing system 62 cooperate to further provide functional dispensing interaction that is decorative, the closure system 60 providing a seat for a rigid decorative object inside the bottle without interfering with the dispensing of product;
a volume defined by the closure system is at least 15%, possibly at least 50%, of the volume of the bottle.

Furthermore, the present description is considered to include several other inventions, such as a bottle comprising:
a glass container body 2 comprising a mouth 61,
a closure system 60 hermetically assembled to the glass container body 2 so as to close the mouth 61, the closure system comprising an outer cover 73, the closure system 60 comprising a dispensing through-hole 80,
a product dispensing system 62 comprising at least one dispensing member 30 assembled so as to provide access to a product that may be contained in the bottle, through the dispensing through-hole 80, wherein the closure system 60 and the dispensing system 62 cooperate to further provide a functional dispensing interaction chosen from among:
the dispensing through-hole 80 is a first dispensing through-hole, the dispensing member 30 is a first dispensing member, the closure system 60 comprises a second dispensing through-hole 180, and the product dispensing system 62 comprises a second dispensing member 130 assembled to the closure system 60, to provide access to a product that may be contained in the bottle, through the second dispensing through-hole 180;
the cover 73 forms a housing 84 for the dispensing member 30, the closure system 60 and dispensing system 62 cooperating to provide a functional dispensing interaction that protects against accidental actuation of the dispensing member;
a longitudinal axis of the dispensing member 30 is oriented at an angle of at least 15° relative to a normal to the cover 73;
the dispensing member 30 is mounted so as to be movable relative to the cover 73 between a first position and a second position with a first degree of freedom, the closure system 60 comprising a system for stably retaining the dispensing member 30 relative to the cover 73 in at least one of the first and second positions, and in particular in both the first and second positions, the closure system 60 and the dispensing system 62 cooperating to provide a functional dispensing interaction with mobility;
the closure system 60 and the dispensing system 62 cooperate to provide a functional dispensing interaction with inclination between the dispensing system and the closure system; and/or
the closure system 60 and the dispensing system 62 cooperate to further provide a functional dispensing interaction that is decorative, the closure system 60 providing a seat for a rigid decorative object inside the bottle without interfering with the dispensing of product.

According to some embodiments, the bottle comprises one or more of the advantageous characteristics mentioned above.

1. A bottle, wherein the bottle comprises:
a glass container body comprising a mouth of non-circular shape,
a closure system hermetically assembled to the glass container body so as to close the mouth, the closure system comprising an outer cover, the closure system comprising a dispensing through-hole,
a product dispensing system comprising at least one dispensing member assembled so as to provide access to a product that may be contained in the bottle, through the dispensing through-hole,
wherein the closure system and the dispensing system cooperate to further provide a functional dispensing interaction.

2. The bottle according to claim 1, wherein the dispensing through-hole is a first dispensing through-hole, wherein the dispensing member is a first dispensing member, wherein the closure system comprises a second dispensing through-hole, and wherein the product dispensing system comprises a second dispensing member assembled to the closure system, to provide access to a product that may be contained in the bottle, through the second dispensing through-hole.

3. The bottle according to claim 2, wherein the first and second dispensing members differ in at least one characteristic selected from the following:
the volume dispensed by the dispensing,
the dispensing mode,
the dispensing type,
in the case of dispensing by spraying, the size distribution of the sprayed droplets,
in the case of dispensing by spraying, the spatial three-dimensional shape of the dispensed volume.

4. The bottle according to claim 2, wherein the closure system is assembled to the glass container body so as to define first and second receptacles that are sealed relative to one another, and wherein the first dispensing member is adapted to provide access to a product contained in the first receptacle, and wherein the second dispensing member is adapted to provide access to a product contained in the second receptacle.

5. The bottle according to claim 4, wherein the first and second receptacles have one or more of the following characteristics:
an identical external shape,
an external shape that is symmetrical to one another,
an external shape that is different from one another,
an external shape that is asymmetrical to one another,
an identical internal shape,
an internal shape that is symmetrical to one another,
an internal shape that is different from one another,
an internal shape that is asymmetrical to one another,
an identical volume plus or minus 10%,
a volume that differs by at least 10%,
a volume that differs by at least 50%,
identical external decoration,
different external decoration,
identical internal decoration,
different internal decoration.

6. The bottle according to claim 4, wherein the two receptacles are hermetically defined relative to one another by a casing attached to the closure system.

7. The bottle according to claim 1, wherein the mouth comprises an assembly interface, wherein the closure system comprises a base, a sealing interface extending from the base, the assembly interface of the mouth and the sealing interface of the closure system cooperating for a hermetic assembly of the closure system and the glass container body, at least one dispensing through-hole and in particular each dispensing through-hole being formed in the base.

8. The bottle according to claim 7, wherein the base forms the outer cover.

9. The bottle according to claim 7, wherein the closure system comprises sealing part and a locking part covering the sealing system, the locking part forming the cover, the at least one dispensing through-hole being formed by the superposition of a through-hole in the locking part and a through-hole in the sealing part, through which the dispensing member extends.

10. The bottle according to claim 9, wherein the locking part clasps the sealing part to ensure the hermetic assembly between the closure system and the glass container body.

11. The bottle according to claim 1, wherein the closure system comprises a neck, wherein the dispensing through-hole is created at least partially in the neck, and wherein the dispensing member is assembled onto the neck of the closure system.

12. (canceled)

13. (canceled)

14. (canceled)

15. The bottle according to claim 1, wherein the cover forms a housing for the dispensing member, the closure system and the dispensing system cooperating to provide a functional dispensing interaction that protects against accidental actuation of the dispensing member.

16. The bottle according to claim 15, wherein the cover has at least one wall partially surrounding the dispensing member and extending about a longitudinal axis of the dispensing member.

17. The bottle according to claim 16, wherein the cover further has a wall extending transversely to the longitudinal axis of the dispensing member.

18. The bottle according to claim 1, wherein a longitudinal axis of the dispensing member is oriented at an angle of at least 15° relative to a normal to the cover.

19. The bottle according to claim 1, wherein the dispensing member is mounted so as to be movable relative to the cover between a first position and a second position with a first degree of freedom, the closure system comprising a system for stably retaining the dispensing member relative to the cover in at least one of the first and second positions, and in particular in both the first and second positions, the closure system and the dispensing system cooperating to provide a functional dispensing interaction with mobility.

20. (canceled)

21. (canceled)

22. (canceled)

23. The bottle according to of claim 1, wherein the closure system is hermetically assembled to the glass container body so as to close the mouth permanently.

24. (canceled)

25. The bottle according to of claim 1, wherein the closure system and the dispensing system cooperate to provide a functional dispensing interaction with inclination between the dispensing system and the closure system.

26. The bottle according to of claim 1, wherein the closure system and the dispensing system cooperate to further provide a functional dispensing interaction that is decorative, the closure system providing a seat for a rigid decorative object inside the bottle without interfering with the dispensing of product.

27. (canceled)

28. A bottle, wherein the bottle comprises:
a glass container body comprising a mouth of circular shape,
a closure system hermetically assembled to the glass container body so as to close the mouth, the closure system comprising an outer cover, the closure system comprising a dispensing through-hole,
a product dispensing system comprising at least one dispensing member assembled so as to provide access to a product that may be contained in the bottle, through the dispensing through-hole,
wherein the closure system and the dispensing system cooperate to further provide a functional dispensing interaction.

29. A bottle, wherein the bottle comprises:
a glass container body comprising a mouth,
a closure system hermetically assembled to the glass container body so as to close the mouth, the closure system comprising an outer cover, the closure system comprising a dispensing through-hole,
a product dispensing system comprising at least one dispensing member assembled so as to provide access to a product that may be contained in the bottle, through the dispensing through-hole,
wherein the closure system and the dispensing system cooperate to further provide a functional dispensing interaction chosen from among:
the dispensing through-hole is a first dispensing through-hole, the dispensing member is a first dispensing member, the closure system comprises a second dispensing through-hole, and the product dispensing system comprises a second dispensing member assembled to the closure system, to provide access to a product that may be contained in the bottle, through the second dispensing through-hole;
the cover forms a housing for the dispensing member, the closure system and dispensing system cooperating to provide a functional dispensing interaction that protects against accidental actuation of the dispensing member;
a longitudinal axis of the dispensing member is oriented at an angle of at least 15° relative to a normal to the cover;
the dispensing member is mounted so as to be movable relative to the cover between a first position and a second position with a first degree of freedom, the closure system comprising a system for stably retaining the dispensing member relative to the cover in at least one of the first and second positions, and in particular in both the first and second positions, the closure system and the dispensing system cooperating to provide a functional dispensing interaction with mobility;
the closure system and the dispensing system cooperate to provide a functional dispensing interaction with inclination between the dispensing system and the closure system; and/or
the closure system and the dispensing system cooperate to further provide a functional dispensing interaction that is decorative, the closure system 60 providing a seat for a rigid decorative object inside the bottle without interfering with the dispensing of product.
